(19) United States
(12) Patent Application Publication
(10) Pub. No.: US 2006/0187533 A1
(43) Pub. Date: Aug. 24, 2006

(54) Method and device for time-gated amplification of photons

(76) Inventors: Tim Nielsen, Hamburg (DE); Sascha Kruger, Hamburg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/547,589

(22) PCT Filed: Mar. 3, 2004
(86) PCT No.: PCT/IB04/00555

§ 371 Date: Sep. 1, 2005

(30) Foreign Application Priority Data
Mar. 7, 2003 (EP) 031005697

(51) Int. Cl. H01S 3/00

(52) U.S. Cl. 359/333

(57) ABSTRACT

The invention relates to a method for the selective amplification of signal photons of a signal pulse (4) in a desired time window. For this purpose, the signal photons (4) are passed through an activated amplification medium (1), where amplification takes place by induced emissions. The amplification is terminated at a desired point in time by the irradiation of a quench pulse (7). Optionally, the start of amplification can be determined by an irradiated pump pulse (8). Emissions that are not correlated with the signal pulse (4) can be suppressed by means of a spectral filter (2). Furthermore, an intensity filter such as a saturable absorber (3) can suppress unamplified fractions of the emission (5) leaving the amplification medium (1). Applications of the method include medical optical imaging and tomography by transillumination with time-gated detection of ballistic photons.

The invention relates to a device and a method which can be used to selectively amplify signal photons in a predefined time window.

U.S. Pat. No. 6,445,491 B2 discloses a device by means of which signal photons scattered or reflected by an object can be selectively amplified in a time window. The signal photons are passed through a nonlinear optical medium (laser medium) into an imaging system. In parallel with the signal light, a pump pulse having a pump frequency is irradiated into the nonlinear optical medium in order to activate the latter. Signal photons which pass through the medium at the same time as the pump pulse are then amplified by induced emissions, unlike the rest of the signal photons. A disadvantage of the method is that the shape and width of the time window for the amplification is predefined or limited by the pump pulse. Very narrow and clear-cut time windows can therefore rarely be implemented. Furthermore, the frequencies of the pumping light and of the signal photons must be different, so that the process has to be carried out either with different light sources or with frequency converters.

Against this background, it is an object of the present invention to provide alternative means for the selective amplification of signal photons in a time window, which are intended to preferably permit the implementation of very narrow time windows.

This object is achieved by a method having the features of claim 1 and by a device having the features of claim 6. Advantageous refinements are given in the dependent claims.

The method according to the invention for the selective amplification of signal photons in a time window comprises the following steps:

a) The signal photons are irradiated into an activated amplification medium (for example a laser medium), where they are amplified by induced emissions.

b) The amplification medium is deactivated at the end of the desired time window by a quench pulse of a suitable quench frequency being irradiated into the amplification medium.

Such a method allows active amplification of the signal photons irradiated into the activated amplification medium until the point in time at which the quench pulse deactivates the medium. This point in time can be predefined by the irradiation of the quench pulse, so that a start phase that can be almost as short as desired can be selectively amplified by one irradiated signal pulse, while the rest of the signal pulse passes through the medium unamplified. Furthermore, the method is advantageous in that the frequency of the signal photons and of the quench pulse may be the same, so that both can be generated by the same light source. This simplifies the complexity of the apparatus for carrying out the method.

According to a first specific embodiment of the method, the quench pulse is irradiated into the amplification medium essentially perpendicular to the direction of propagation of the signal photons. This minimizes the risk of photons of the quench pulse (or photons induced thereby) emerging from the amplification medium in the direction of the signal photons and being falsely interpreted as signal photons. The front formed by the photons of the quench pulse is preferably inclined relative to the direction of propagation of the signal photons in such a way that it first comes into contact with the amplification medium in the vicinity of the irradiation side of the signal photons. In this way, the bundle of rays of signal photons can be subdivided in as “straight” a manner as possible, that is to say perpendicular to its direction of propagation, into an amplified section and an unamplified section.

According to a second specific embodiment of the method, the quench pulse is irradiated into the amplification medium approximately parallel to the direction of the signal photons that are to be amplified. A slight deviation from parallelism should be present in order that signal photons and photons of the quench pulse may still be separate on the output side and there is no falsification of the measurement result. Otherwise, however, the wave fronts of the signal photons and of the quench pulse run approximately parallel so that there is essentially simultaneous deactivation of the amplification over the entire width of the amplification medium and accordingly a particularly precisely defined time window is selected from the signal pulse.

In one embodiment of the method, the amplification medium is activated by a pump pulse (only) after the start of irradiation of the signal photons. The signal photons hence do not come into contact with an activated amplification medium right from the start, so that they first pass through the latter unamplified. Only after the medium has been activated by the pump pulse does the amplification of the signal photons begin, and said amplification lasts until the amplification medium is deactivated again by the quench pulse. By means of this procedure, it is possible to amplify in a specific manner a time window which lies in the central region of the signal pulse. Since the pump pulse and the quench pulse are two processes that are independent of one another, they may in principle lie as close to one another as desired in time terms so that very narrow time windows can be selectively amplified. The pump pulse and the quench pulse are advantageously irradiated in parallel with one another.

The emission coming from the amplification medium in the direction of the signal photons is preferably filtered. The filtering may in particular relate to the spectrum, the polarization and/or the intensity of the emission. A spectral filtering may screen out photons that are emitted spontaneously by the amplification medium and have a different frequency from the signal photons, in order that they do not falsify the measurement result. The unamplified fraction of the signal photons may be separated from the amplified fraction by means of intensity filtering. In particular, the unamplified fraction of the signal photons can be suppressed so that it no longer plays any part in the further processing.

The invention also relates to a device for the selective amplification of signal photons in a time window. The device comprises an activatable amplification medium into which the signal photons to be amplified can be irradiated. It furthermore comprises a quenching device by means of which a quench pulse that deactivates the amplification medium can be irradiated into the amplification medium.

Said device can be used to carry out the method described above, so that the advantages of the latter can be obtained. The device may be designed such that it can also be used to carry out the abovementioned variants of the method.

In particular, the device may have a pump device for irradiating a pump pulse that activates the amplification medium. By irradiating a pump pulse, the start of the time window for the amplification can be defined independently of the start of the passing in of the signal photons, via the activation of the amplification medium.

According to a preferred embodiment, the device may have a light source for generating a light pulse and a beam splitter for splitting said light pulse into a signal pulse of signal photons to be amplified and a quench pulse. The pulse of signal photons may image an object e.g. in reflection or transmission or trigger a fluorescence (e.g. of marker substances) in the object. From the reflected/transmitted light or the fluorescent light, then, only signal photons from a determined time window are amplified and used for imaging. The quench pulse, which deactivates the amplification medium once it has been passed into the latter and thus terminates the amplification, is in such a device advantageously generated by the same light source as the signal photons.

Preferably, a spectral filter, a polarization filter and/or a saturable absorber are arranged in the device in the direction of emergence of the amplified emission. By means of a spectral filter, (spontaneous) emissions which are not consistent with the signal photons can be screened out. A saturable absorber absorbs incident radiation up to a defined maximum intensity in accordance with a saturation limit, and allows through the intensity above this saturation limit. By means of such an absorber, the unamplified photon emission of the amplification medium can thus be retained and only the amplified photon fraction in the correct time window allowed through.

In a preferred application of the device, the signal photons are emitted by an instrument which is hidden by a (for example biological) body. The instrument may in particular be a catheter inserted into the vascular system of a patient. Furthermore, in this application the time window for the amplification is selected such that only signal photons of direct radiation are amplified, that is to say only those signal photons which use the shortest route to pass from the point of emission on the instrument to the amplification medium. This has the advantage that scattered signal photons do not arise within the predefined time window and therefore are excluded from the amplification and imaging. It is thus possible for an optically sharp image of the point of emission on the instrument to be generated even if there should be a high level of scattering of the signal photons within the body. The latter is particularly the case in respect of signal photons of the near infrared (NIR), which on the other hand are capable of penetrating biological tissue to a considerable depth without causing any damage.

Further details regarding the abovementioned use are to be taken from the patent application having the title “Device and method for locating an instrument within a body” (European Patent Application EP03100567.1), filed by the same applicant at the same time, the contents of which are hereby incorporated by reference into the present application.

The invention also concerns optical molecular imaging devices, optical tomography devices or optical time-resolved spectroscopy devices, which comprise the inventive device.

The invention and its technology can also be used in the well-known field of optical imaging, notably optical molecular imaging. Optical molecular imaging means imaging of a typically low concentration of specific target molecules by optical imaging techniques, particularly imaging of the spatially and/or temporally resolved distribution of the target molecules in the object under investigation. Several of said optical imaging techniques are being described in the following.

A target molecule can be a molecule pertaining to the object under investigation, e.g. an expressed protein, or it can be a molecule artificially introduced into the object, e.g. a drug. The target molecules may be labeled with an optical marker (i.e. fluorescent marker, sometimes also named optical contrast agent) that allows their detection in an optical molecular imaging system. A typical optical molecular imaging system consists of an examination area in which the object (cells, tissue, body, . . . ) under investigation is located. The object comprises inside or on its surface the target molecules that should be detected. A further system component is a detector for detecting the optical quanta (e.g. from the visible light regime, NIR, UV) that is emitted (e.g. triggered by excitation of the target molecule itself or the fluorescent marker) or scattered by the target molecules (e.g. after irradiation of the object that comprises the target molecules). The present invention can be used in the detector to achieve very high temporal resolution. An optical molecular imaging system may also comprise as a third component a light source that irradiates the target molecules so that the scattered quanta can be detected by the detector.

One known labeling technique is to label target molecules (e.g. expressed proteins, drugs) with fluorescent dyes. The emitted fluorescence is then used to detect the target molecules. One problem in fluorescence imaging is background fluorescence from the often likewise fluorescent surrounding of the target molecules. Background fluorescence can be distinguished from fluorescence originating from the target molecules by analyzing spectrum, polarization and temporal development of these quantities (i.e. fluorescence decay time (spectrally resolved) and time-dependent depolarization). High temporal resolution is essential in this task because a typical timescale for these processes is in the pico-second to nano-second range.

The invention and its technology can be used to suppress such background fluorescence to enhance the detection of characteristic fluorescence photons from a target molecule, whereby the fluorescence may originate from the target molecule itself or the fluorescent marker attached to it. The invention allows for fluorescence decay time measurements by applying several gating windows with high temporal resolution and vanishing jitter. Thus very accurate lifetime maps of the imaged region can be measured. These lifetime maps can be used to simply distinguish a target molecule from surrounding tissue because they have a different lifetime. The lifetime maps can also be used to derive information about the chemical environment of the target molecules (i.e. information about chemical bonds or parameters of these bonds like the strength), if the lifetime map information is combined with spectral information to separate the fluorescence signal of the target molecules from background fluorescence. The invention is also useful for the development and rating of the specificity of new target molecules (drugs).

Additional advantages of optical molecular imaging, especially in combination with the invention, are high sensitivity, non-invasiveness and fast imaging speed paired with relatively low costs of the equipment. In contrast to molecular imaging via known nuclear medical imaging this optical technology can also be used for follow-up studies as the contrast agents can be imaged several times over a time interval of many days. Additionally, the present invention allows a gated acquisition protocol for motion aware excitation and image acquisition in case of moving organs. It is noted that retrospective gating (as e.g. done in SPECT) would imply unnecessary photon bleaching due to continuous acquisition here.

The invention can also be used in the known technical field of optical tomography. With an optical tomography system one can acquire images of the volume distribution of optical scattering coefficients and optical absorption coefficients of the object under investigation and/or the three-dimensional distribution of fluorescent target molecules.

Typical optical tomography systems illuminate the object with light from different directions and detect the light leaving the object under different directions. Either continuous-wave (cw), pulsed or modulated light sources are used for the illumination. With a detector, the light can be detected, particularly time-resolved or phase-sensitive if a pulsed or a modulated light source is used. In order to enhance the image quality current optical tomography systems use photon time-of-flight discrimination in the image reconstruction process. Including the invention in the detector, extremely narrow timing windows can be realized in order to improve the signal to noise ratio of such a system. An optical molecular tomography system typically uses an excitation source that excites the (labeled) target molecules and the detector measures the emitted fluorescent light under various directions. Known reconstruction techniques can be used to reconstruct the three-dimensional distribution of the target molecules, e.g. by also applying information on optical properties of the object that contains the target molecules.

A different approach to imaging the three-dimensional optical absorption coefficient is ballistic photon imaging. This technique is equivalent to known x-ray projection imaging, in the sense that these systems aim to detect only non-scattered (or primary) photons. Passing the object under investigation, non-scattered photons arrive early (or first) at a detector. Hence, very high time-resolution is needed in order to separate the non-scattered photons from the scattered ones. Then, a detection of only the non-scattered photons is possible. This can be realized by utilizing the invention in such a photon detection system as the high temporal resolution of the proposed photon amplification technique enables a very efficient detection of non-scattered photons. In this case volume imaging can be performed with less elaborate reconstruction algorithms (known computer tomography reconstruction algorithms can be used) by projection imaging from different directions.

The invention can also be used in the known field of optical time-resolved spectroscopy with extremely high temporal resolution. Typical systems also comprise a light source, an examination area in which the object under investigation is located and a detector. If the detector comprises the invention, a high temporal resolution can be achieved. Thus, a better analysis of the emission of fluorescence photons from the object can be achieved. This technology would also be applicable to detection and staging of superficial tumors in hollow organs or on the skin with enhanced specificity by adding fluorescence lifetime information to the analysis. The technology is also applicable in the analysis of fluorescent compounds in a pre-clinical phase, e.g. screening of animals or cell-cultures or micro/nano-titer plates, or fluorescence microscopy. Furthermore, the invention can be used in several medical applications like optical mammography, optical diaphanoscopy and optical diagnostic imaging of arthropathies (rheumatoid arthritis).

The invention will be further described with reference to examples of embodiments shown in the drawings to which, however, the invention is not restricted. Identical components are provided in the figures with identical references and are therefore in general only described once.

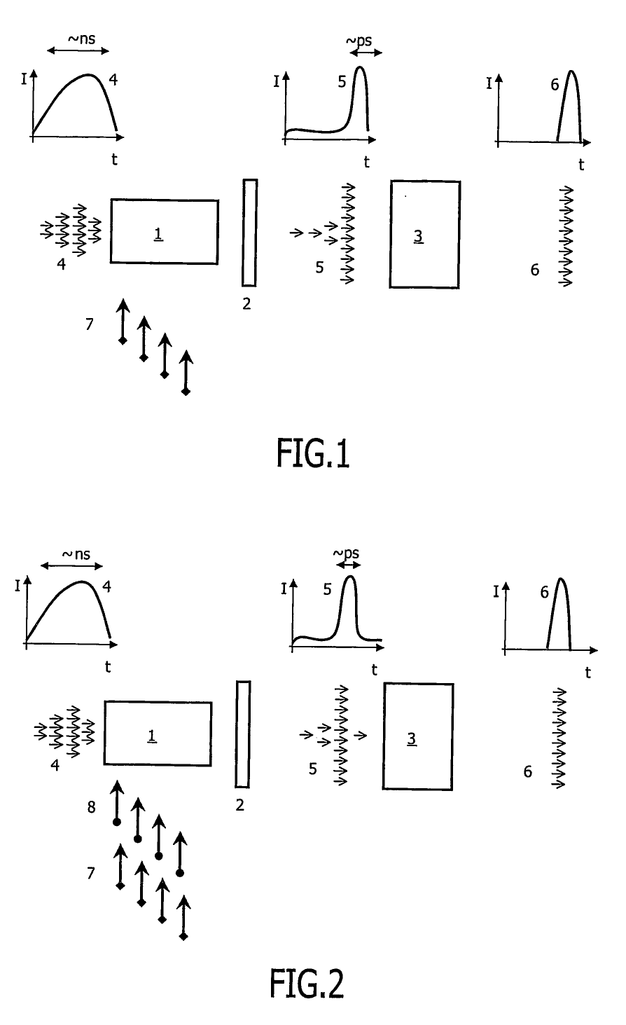

FIG. 1 shows the principle of amplification of a signal photon pulse up to irradiation of a quench pulse.

FIG. 2 shows a variant of the method of FIG. 1, in which the start of amplification is defined by the irradiation of a pump pulse.

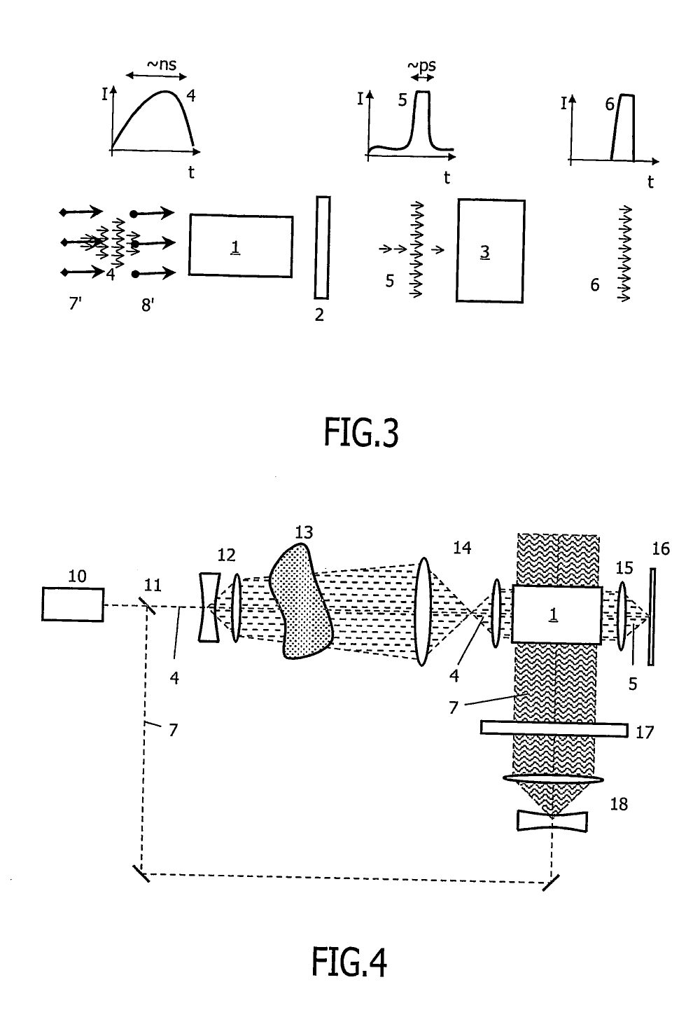

FIG. 3 shows a variant of the method of FIG. 2, in which the pump pulse and the quench pulse are irradiated in parallel with the signal photons.

FIG. 4 shows a diagram of the apparatus used to image a light source hidden by a body.

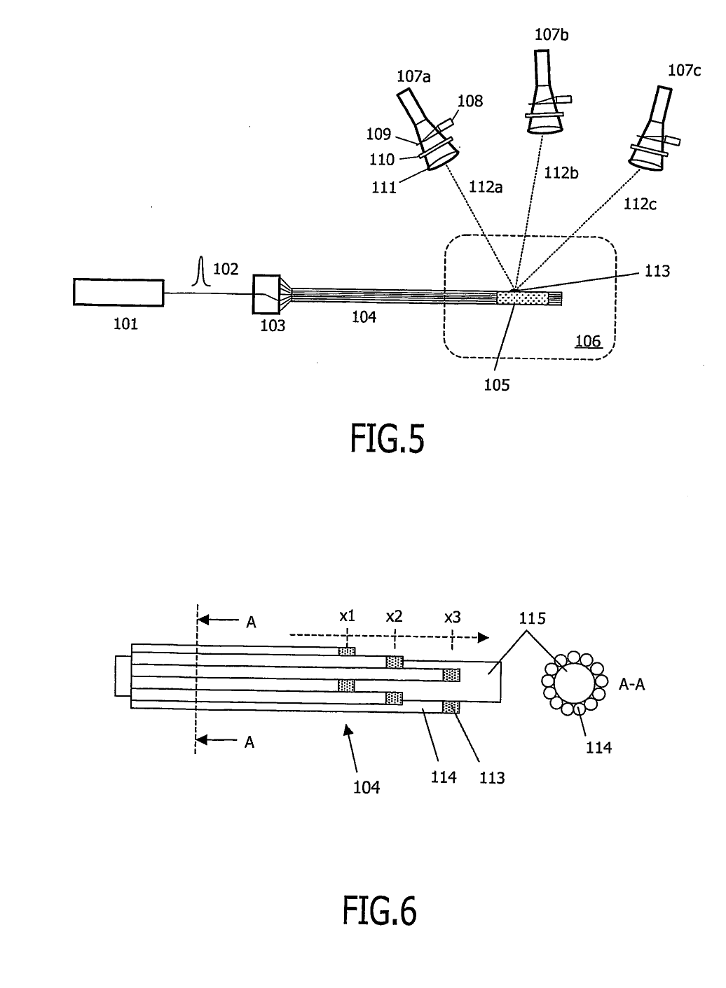

FIG. 5 schematically shows a set-up for locating a catheter inserted into the body.

FIG. 6 shows a side view and a cross section of a catheter suitable for the locating method.

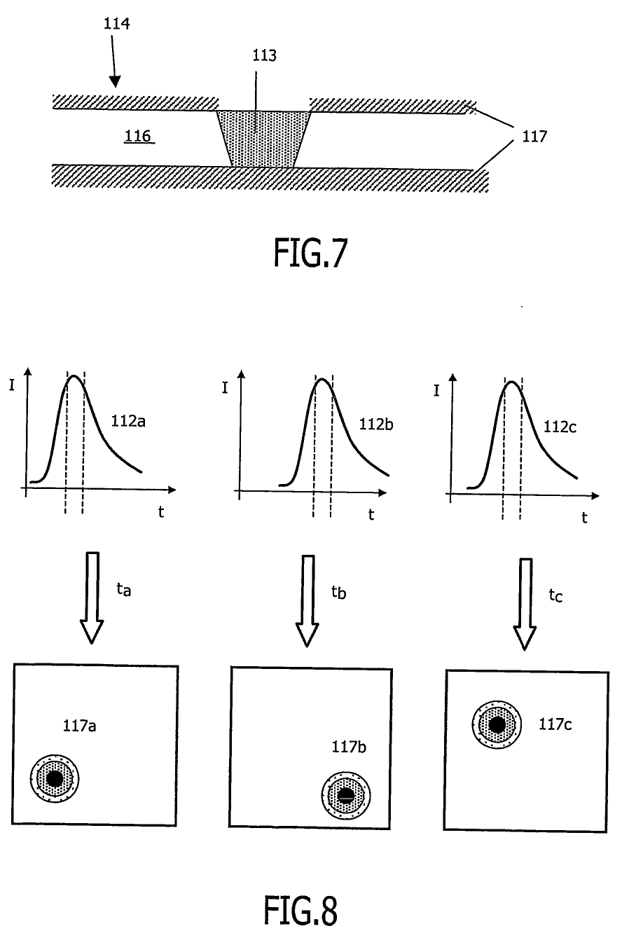

FIG. 7 shows a longitudinal section through a light guide of the catheter of FIG. 6.

FIG. 8 shows the imaging of NIR signal pulses on the detectors used.

FIG. 1 schematically shows the mode of operation of a novel method for the selective amplification of signal photons. The most important part of the associated set-up is an amplification medium 1, which may for example be a laser medium. The atoms or molecules of the amplification medium 1 may be converted to an excited state by irradiating pumping light of suitable pump frequency, as a result of which the population states of the medium with respect to the thermal equipartition are inverted. This procedure is referred to hereinbelow as “activation of the amplification medium”.

When signal photons 4 of suitable frequency are irradiated in, this results in an induced emission in the activated amplification medium 1, which induced emission leads to the desired amplification of the irradiated pulse of signal photons 4. The magnitude and the amplification of the medium 1 must in this case be selected in a suitable manner in order to allow good amplification of the signal (preferably in a single pass of the signal photons 4 through the amplification medium, although a number of passes are also possible) and hence allow use thereof in an imaging method. In this respect, for example, a laser medium 1 such as titanium:sapphire having a diameter of about 5 mm and a length (measured in the direction of the irradiated signal photons 4) of 20 mm is suitable. On account of the typically low intensity of the signal pulse 4, an exponential amplification response by the stimulated emission can be expected.

In the set-up shown in FIG. 1, a quench pulse 7 is passed through the amplification medium 1 perpendicular to the direction of incidence of the signal photons 4. The photons 7 of the quench pulse, by breaking down the excited states, bring about deactivation of the amplification medium 1. A high-power laser (e.g. Ti:Sa laser, not shown) having a pulse width of less than 1 ps may be used to generate the quench pulse 7. The intensity of such a laser is high enough to completely deactivate the amplification medium 1. The deactivation leads to the irradiated signal photons 4 no longer being amplified when they pass through the amplification medium 1 after the quench pulse 7. In this way, the quench pulse can be used to define the point in time until which amplification takes place in the amplification medium 1. The quench pulse 7 is preferably irradiated with a front that is inclined relative to the direction of propagation of the signal photons 4, in order that the amplification of the signal photons 4 is “cut off” as precisely as possible with respect to the width of the amplification medium 1.

The signal pulse 4 is stretched by scattering processes generally to a duration of a number of nanoseconds in accordance with a geometric length of the pulse in the order of magnitude of 30 cm. A complete cross section of the amplification medium 1 perpendicular to the direction of propagation of the signal pulse 4 is deactivated by the quench pulse 7 at a diameter of the amplification medium of 5 mm within 15 ps. By contrast, on account of capacitances, electrical resistances and geometric properties conventional photomultiplier tubes are limited to switching times of a number of nanoseconds. Compared to this, the proposed method represents an improvement of more than two orders of magnitude.

A bandpass filter 2 is arranged on the emergence side of the amplification medium 1, by means of which bandpass filter principally a broadband signal of amplified spontaneous emission is suppressed which is not in any temporal correlation with respect to the signal pulse 4 and is emitted spontaneously by the amplification medium 1 as long as the latter is in an activated state. The amplified signal pulse 5 leaving the spectral filter 2 has the profile shown schematically in the associated central diagram (intensity I over time t), in which the leading edge of the original signal pulse 4 is amplified compared to the rest of the signal, with a width in the picosecond range. In order to emphasize this intensity peak even more, the signal pulse 5 is passed through a saturable absorber 3, which only allows through the photons which lie above its saturation limit. The saturable absorber 3 may be for example a saturable absorber mirror of semiconductor material (SESAM) (cf. Keller, U., Miller, D. A. B., Boyd, G. D., Chiu, T. H., Ferguson, I. F., Asom, M. T., Opt. Lett. 17, 505 (1992); U. Keller, K. J. Weingarten, F. X. Kärtner, D. Kopf, B. Braun, I. D. Jung, R. Fluck, C. Hönninger, N. Matuschek, J. Aus der Au, IEEE J. Sel. Top. Quantum Electron. 2, 435, (1996); U. Keller in Nonlinear Optics in Semiconductors, edited by E. Garmire and A. Kost (Academic, Boston, Mass., 1999), Vol. 58, p. 211). Depending on the amplification factor, other intensity filters could also be used. If the amplification is very high, the step of intensity filtering may where appropriate also be completely omitted.

FIG. 2 shows a further developed set-up for carrying out a selective amplification. The essential difference with respect to the set-up of FIG. 1 is that the amplification medium 1 is activated by a pump pulse 8 of light of suitable pump frequency. In the example shown, the pump pulse 8, like the quench pulse, is irradiated perpendicular to the direction of propagation of the signal photons 4 that are to be amplified. The amplification medium 1, which is initially inactive, is activated by the pump pulse 8 at a desired point in time with light velocity, as a result of which the start of the time window for the amplification can be defined. In particular, the amplification can in this way take place in a central region of the signal pulse 4. The remainder of the method comprising the spectral filtering by the filter 2 and the absorption of unamplified signal photons by the saturable absorber 3 is analogous to FIG. 1.

FIG. 3 shows a further variant. The difference with respect to the set-ups of FIG. 1 and FIG. 2 is that the pump pulse 8′ (if such a pulse is used) and the quench pulse 7′ are irradiated into the amplification medium 1 approximately parallel to the signal pulse 4. There should be a slight inclination of typically about 0° to about 20° between the direction of propagations of pump pulse and quench pulse on the one hand and signal pulse on the other hand, in order to avoid an undesirable mixing of the rays on the output side. Furthermore, the pump pulse 8′ and the quench pulse 7′ are preferably broadband whereas the signal is narrow-band, in order that the separation of signal pulse on the one hand and quench pulse/pump pulse on the other hand, by means of a spectral filter, is more easily possible.

By means of the approximately parallel running of the wave fronts of signal pulse 4, pump pulse 8′ and quench pulse 7′, it is possible, from the signal pulse, for photons having a high selectivity from a desired time window to be amplified selectively. In the case of approximately planar waves, signal photons of the same time window all lie for example in the same plane or planar layer, which can be located very precisely between two planar wave fronts of pump pulse and quench pulse. The precise definition of the time window can moreover be used to select the width of the time window to be very small (typically in the order of magnitude of femtoseconds).

FIG. 4 schematically shows one specific use of the proposed method for the selective amplification of signal photons. The set-up shown comprises as light source a laser which transmits short light pulses having a duration in the order of magnitude of nanoseconds and a frequency in the near infrared NIR range (0.65 μm to 3 μm). The light pulse of the laser 10 is split by a beam splitter 11 into a signal pulse 4 and a quench pulse 7 (alternatively the quench pulse 7 could also be generated by a separate laser). The signal pulse 4 is passed over suitable optics 12 onto or through an object 13 that is to be examined, such as a tissue sample for example, and then shaped by further optics 14 to form a parallel bundle of rays, said bundle of rays passing in the longitudinal direction through an amplification medium 1 of the type described in FIGS. 1 to 3. The (amplified) emission light 5 leaving the amplification medium 1 is bundled by further optics 15 on a detector plane 16, for example a CCD chip, to generate a geometric image.

The quench pulse 7 generated at the beam splitter 11 is passed via tilted mirrors and optics 18 such that it passes through the amplification medium 1 as a parallel bundle of rays perpendicular to the direction of the signal bundle 4. A phase shifter 17 may additionally be placed between the optics 18 and the amplification medium 1. The point in time at which the quench pulse 7 passes through the amplification medium 1 relative to the signal pulse 4 can be set by the length of the light path of the quench pulse 7 from the beam splitter 11 to the amplification medium 1. The amplification medium 1 is thus operated as a selective time window filter unit in the manner described in general terms in FIGS. 1 to 3. That is to say that the activated amplification medium 1 amplifies the irradiated signal pulse 4 until said amplification medium is deactivated following the arrival of the quench pulse 7.

FIG. 4 shows, not in detail, a filter (e.g. spectral bandpass filter, polarization filter, intensity filter or a combination thereof) and a saturable absorber between the optics 15 and the detector 16. By means of the spectral filter, spontaneous emissions of the amplification medium 1 can be screened out. The saturable absorber serves to screen out unamplified fractions of the signal pulse 4.

The optical imaging of a biological tissue 13 for example by means of NIR light is very difficult on account of the high scattering rates in these media. Photons having optical wavelengths are scattered to such a great extent that the probability of multiple scattering is also very high. Imaging with a high spatial resolution therefore requires means for screening out scattered signal photons. On account of the high fraction of multiple-scattered signal photons, collimators directed at the signal source (as in X-ray computer-aided tomography) cannot be used in this respect since on account of the multiple scattering scattered photons may again come from the direction of the signal source. On the other hand—also in view of the availability of coherent, monochromatic high-power lasers at optical wavelengths—the use of optical measurement methods is desirable in medicine since the signal photons at optical wavelengths that are used are not harmful to biological tissue, unlike X-ray radiation for example. Against this background, the abovementioned method offers an advantageous solution since it permits the screening-out of scattered photons by defining a suitable time window.

Besides scattering, the absorption of optical signal photons in biological tissue is also a source of interference. However, this interference can be compensated by using suitable wavelengths such as NIR for example or by relatively long recording durations, which are readily possible on account of the fact that the radiation is not harmful.

Rather than for the generation of a two-dimensional image in the detector plane 16, the set-up shown in FIG. 4 can also be used for (“zero-dimensional”) absorption measurements. Such measurements may also be carried out on a number of lines. Furthermore, the method can be expanded to a tomographic image generation system (cf. Schmidt, F. E. W., Development of a Time-Resolved Optical Tomography System for Neonatal Brain Imaging, PhD thesis, University College London, 1999; Huijuan Zhaol, Feng Gaol, Yukari Tanikawa, Yoichi Onodera, Masato Ohmi, Masamitsu Haruna and Yukio Yamada, Imaging of in vitro chicken leg using time-resolved near-infrared optical tomography, Phys. Med. Biol. 47 (2002) 1979-1993) or be used in the field of “optical computing” or as a pulse picker.

The present invention thus provides a technology which permits the precise amplification of very short section of light pulses. This may be used to aid imaging methods which are based on a differencing of the propagation time of signal photons having a high temporal and spatial resolution. The method is particularly suitable for the optical imaging of highly heterogeneous media, in which there is a high degree of scattering of signal photons having optical wavelengths.

A fundamental principle of the invention is the use of an active amplification medium to amplify the signal pulse, where short laser pulses switch the amplification of the medium on and off as the signal pulse passes through, in order to amplify only a very short time slice of the signal pulse. This switching is made possible by a rapid pumping and/or quenching of an amplification medium with a reference laser pulse. In order to amplify the leading edge of a signal pulse, only one quench pulse is required which may be generated by the same laser as the signal pulse or by a separate laser.

The locating of a catheter will be described in more detail below with reference to FIGS. 5 to 8. In this respect, FIG. 5 schematically shows a catheter 104 which has been inserted into a volume of interest 106, such as the heart region of a patient for example. In order to be able to monitor the use of the catheter 104 and the carrying out of diagnostic and/or therapeutic measures, it is important to locate the catheter or at least a relevant section thereof (e.g. the tip) as precisely as possible. One such location operation is achieved according to the invention by the emission of NIR light from an emission section 105 of the catheter 104 and detection thereof outside the body. The detection is carried out by a number of cameras 107a, 107b, 107c from which images can be taken with the aid of stereoscopic methods as to the location of the emitting section 105. One embodiment of this principle that is shown in the figures is described in more detail below.

The tip of the catheter 104 that is to be located by means of the method is shown schematically in FIG. 6 in a side view (on the left) and in cross section along the line A-A (on the right). The catheter 104 has a number of typically 100 NIR light guides 114 which are arranged around the catheter core 115. For reasons of clarity, only much fewer light guides are shown in FIG. 6. The core 115 of the catheter 104 is of no independent significance for the locating method currently under consideration. It may be used to accommodate other catheter functions, a guidewire or the like.

The light guides 114 are modified in that at the end they have short sections 113 that have a length of about 100 μm and contain or are composed of a material that scatters NIR radiation to a great extent. FIG. 7 shows such a scattering section 113 in a longitudinal section through a light guide 114. The scattering section 113 should be dense enough to ensure an isotropic emission of the NIR radiation and hence virtually constant signal strengths for all orientations of the catheter, and also prevent measurement errors. The scattering sections are preferably formed by moving the sheath 117 and the core 116 of a light guide 114 away from one another over a length of about 100 μm, with the resulting gap then being filled with an NIR-scattering material. A scattering efficiency of 100% is to be desired in this case. A suitable material is for example an adhesive including small particles or gas bubbles, as a result of which very dense variations of the refractive index are generated.

With 100 light guides 114, for example ten different axial positions xᵢ (FIG. 6) could be produced on a catheter of 3 French (i.e. about 1 mm diameter), with ten emission points 113 distributed in a ring-like manner over the circumference being involved at each axial position. As an alternative, 100 emission points distributed in a ring-like manner over the circumference could be formed at a single axial position, in order to be able to trace for example in a targeted manner a specific point such as the catheter tip for example. The diameter of the light guide would in this case typically be 50 μm, and this corresponds to the size of commercially available light guides.

As can be seen in FIG. 5, the locating device comprises a laser 101 which provides NIR laser pulses 102 having a wavelength of typically 800 nm and a pulse duration of about 1 ps or less (corresponding to a pulse length of 300 μm). These light pulses 102 are passed to a light guide switch 103 and from there optionally fed into an individual light guide (or into a group of light guides) of the catheter 104. The light guide switch 103 permits switching rates in the kHz to MHz range. By actuating this switch 103, it is possible for light pulses 102 coming sequentially from the laser 101 to be transmitted into the various light guides 114 of the catheter 104. From there they are transported to the tip 105 of the catheter, the position of which tip is to be located. Upon reaching the scattering sections 113 on the catheter tip, the laser pulses 102 are isotropically emitted into the interior of the body volume 106.

Outside the body, (at least) three CCD cameras 107a, 107b and 107c are placed at various positions. The NIR light 112a, 112b, 112c transmitted from one emission point 113 to these cameras is picked up by the imaging optics of the cameras. Each of the optics comprises a spectral bandpass filter 110 for NIR light, an imaging element (e.g. a lens 111 or a concave mirror) and a beam splitter 109 (for example a mirror for NIR having a reflectivity of less than 100%, preferably 50%). The cameras 107a, 107b, 107c are in each case coupled to a suitable item of image processing hardware and/or software.

The detectors furthermore comprise image amplifiers and a time window filter unit (not shown) which may operate for example in accordance with the principle shown in FIGS. 1 to 4 and which makes it possible to take into account in a targeted manner only photons from a predefined time window. In particular, it is possible in this way to exclude from the detection photons which have been scattered in the body volume 106, since they arrive with a time delay with respect to the start of the received signal. The photons which arrive “on time” using the direct route are by contrast taken into account in the cameras 107a, 107b and 107c and combined to form a two-dimensional image of the emission point on the catheter 104. From the images thus generated in two or more cameras it is possible to determine the directions of incidence 112a, 112b, 112c of the direct radiation, from which in turn it is possible to locate the spatial position of the emission point 113 on the catheter 104.

The time window that is to be taken into account is determined for each camera 107a, 107b, 107c from a first light pulse with the aid of rapid photomultiplier tubes (PMTs) 108 which are provided at each camera. As can be seen in the schematic drawing of FIG. 8, the propagation times tₐ, t_{b} and t_{c} required by a photon emitted from the emission point 113 to reach the respective camera can be determined from the temporally offset profiles of the measured pulses. The next light pulse emitted by the laser 101 is then picked up by the cameras 107a, 107b, 107c, and this gives the desired two-dimensional images 117a, 117b, 117c of the emission point 113 in the image planes of the cameras. The images 117a, 117b, 117c generated by the detected photons are generally relatively undefined. However, this does not adversely affect the desired location operation, as long as the center point of the respective images can be determined with sufficient accuracy.

In a next step of the catheter location operation, the light guide switch 103 selects a different group of light guides 114 of the catheter 104, the emission points of which lie at a different axial position of the catheter 104, and the described method is repeated. This takes place until all the light guides of the catheter 104 have been processed.

The calculated positions of the emission points 113 of the catheter 104 can be compared with knowledge about the deformation properties of the catheter and/or about the shape of the organ in which the catheter is located. In this way, errors are reduced.

The locating of the catheter 104 is significantly influenced by the photon statistics, an estimate of which is given below. The following initial data are used as a basis: a bundle comprising 100 light guides; a desired refresh rate of the position information of 20 Hz for 10 points distributed over the catheter (that is to say 100/10=10 emission points per point to be located); a 1.5 W Ti:Sa laser; a collimator opening for each camera of about 10⁻⁴ steradian; CCD cameras 107a, 107b, 107c having a quantum efficiency of 20%; an overall light guide transparency of 10%; and a time window for the light pulse in the picosecond range, where the light pulse is stretched in the medium to about one nanometer by means of scattering processes. In this case, about 108 photons may be expected for each camera, each point to be located and each image. These photons arrive at a CCD chip in the order of magnitude of, for example, 500×500 pixels. Each of the three cameras 107a, 107b, 107c detects a complete projection of the volume of interest 106, which has a size of typically 200×200×200 mm³ for example in the case of cardiac examinations. The lateral position of the signal of a camera therefore reflects the projected two-dimensional position of the emission point for the corresponding viewing angle. According to the strength of the photon signal specified above, the spatial resolution of the two-dimensional position determination for an ideal (i.e. punctiform) emission point, which by virtue of scattering and defocusing leads to a blurred signal distribution in each camera, is as expected very high (<100 μm). The focusing depth of each camera and of the optics is in this case adapted to the dimension of the volume of interest. A penetration depth of up to 500 mm may be expected, depending of the type of tissue passed through.

In some applications, a modulation of the refractive index may possibly be carried out if an improvement in the image quality by suppressing scattering processes is necessary (cf. V. V. Tuchin, I. L. Maksimova, D. A. Zimnyakov, I. L. Kon, A. H. Mavlutov, A. A. Mishin, “Light propagation in tissues with controlled optical properties”, J. of Biomedical Optics 1997, 2(4), pp. 401-417).

As an alternative to the set-up comprising three cameras 107a, 107b, 107c shown in FIG. 5, it is also possible to use just two 2D CCD cameras or three 1D CCD arrangements having cylindrical lenses.

The size of the volume 106 that can be examined is limited by the imaging device or the optical arrangement. However, the position of this volume 106 can be varied at will by moving the entire detector assembly. In this respect, self-adaptation is possible in particular, by comparing the number of points to be traced with the number of signals received and the reconstructed path of these signals. From this information it is possible to estimate the necessary movement (magnitude and direction) of the imaging device.

The set-up according to the invention can be expanded in a simple manner to a combined technology which allows robust and precise location and photodynamic therapy measures in the same device. For this purpose, the core 115 of the catheter 104 may comprise additional light guides which transport the light (UV light) necessary for photodynamic therapy.

1. A method for the selective amplification of signal photons (4) in a time window, comprising the steps of:
a) irradiating the signal photons (4) into an activated amplification medium (1) in which they generate induced emissions;
b) deactivating the amplification medium (1) at the end of the time window by irradiating a quench pulse (7, 7′) into the amplification medium.

2. A method as claimed in claim 1, characterized in that the quench pulse (7) is irradiated essentially perpendicular to the direction of propagation of the signal photons (4).

3. A method as claimed in claim 1, characterized in that the quench pulse (7′) is irradiated approximately parallel to the direction of propagation of the signal photons (4).

4. A method as claimed in claim 1, characterized in that the amplification medium (1) is activated by a pump pulse (8, 8′) after the start of irradiation of the signal photons (4).

5. A method as claimed in claim 1, characterized in that the emission (5) coming from the amplification medium (1) in the direction of propagation of the signal photons is filtered, preferably with respect to the spectrum, the polarization and/or the intensity.

6. A device for the selective amplification of signal photons (4) in a time window, comprising an activatable amplification medium (1) into which the signal photons (4) to be amplified can be irradiated, and a quenching device (10, 11, 17, 18) for irradiating a quench pulse (7, 7′) that deactivates the amplification medium (1).

7. A device as claimed in claim 6, characterized in that it has a pump device for irradiating a pump pulse (8, 8′) that activates the amplification medium (1).

8. A device as claimed in claim 6, characterized in that it has a light source (10) for generating a light pulse and a beam splitter (11) for splitting the light pulse into a signal pulse (4) of signal photons to be amplified and a quench pulse (7).

9. A device as claimed in claim 6, characterized in that a spectral filter (2), a polarization filter and/or a saturable absorber (3) is arranged in the direction of the emission (5) leaving the amplification medium (1).

10. A device as claimed in claim 6, characterized in that the signal photons (4) are emitted by an instrument (12), particularly a catheter, that is hidden by a body (13), and in that the time window is selected such that only signal photons of direct radiation are amplified.

11. A device for locating an instrument (104), comprising:
a) at least one detector (107a, 107b, 107c) for the locally resolved detection of signal photons coming from at least one emission point (113) of the instrument (104), whereby the detector comprises at least one device as claimed in claim 6.
b) means for reconstructing the position of the emission point (113) from the measured values of the detector.

12. A catheter for use as an instrument (104) in a device as claimed in claim 11, said catheter comprises at least one emission point (113) of signal photons.

13. A catheter as claimed in claim 12 comprising a number of light guides each of which have at least on light-scattering section that acts as an emission point (113).

14. An optical computer tomography device with at least one detector for detecting signal photons comprising at least one device as claimed in claim 6.

15. An optical computer tomography device as claimed in claim 14 whereby the detector is provided to detect un-scattered signal photons only.

16. An optical molecular imaging device with at least one detector for detecting signal photons comprising at least one device as claimed in claim 6.

17. An optical time-resolved spectroscopy device with at least one detector for detecting signal photons comprising at least one device as claimed in claim 6.
